(19) United States
(12) Patent Application Publication
(10) Pub. No.: US 2019/0325842 A1
(43) Pub. Date: Oct. 24, 2019

(54) DISPLAY ADAPTOR DEVICE FOR WEARABLE DEVICE

(71) Applicant: JORJIN TECHNOLOGIES INC., New Taipei City (TW)

(72) Inventor: Wen-Lung Liang, New Taipei City (TW)

(21) Appl. No.: 15/956,727

(22) Filed: Apr. 18, 2018

(51) Int. Cl. G09G 5/00; G02B 27/01; G06F 3/14

(52) U.S. Cl. CPC G09G 5/006; G06F 3/14; G02B 27/01

(57) ABSTRACT

The display adaptor device connects between an intelligent wearable device and a smart phone. The device includes a casing with a holder socket provided on the casing; a first transmission member including two Universal Serial Bus (USB) ports, one provided inside the holder socket and the other one on an outside surface of the casing; an adaption member including a video processor, an audio codec, a sensor signal processor; and a second transmission member including an input/out (I/O) port on the casing. The first transmission member is electrically connected to the video processor, the audio codec, and the sensor signal processor, which in turn are electrically connected to the second transmission member. A smart phone is plugged in the holder socket. A cable connects the I/O port and an intelligent wearable device. The display adaptor device provides two-way video communications between the wearable device and the smart phone.

### BACKGROUND OF THE INVENTION

### (a) Technical Field of the Invention

The present invention is generally related to wearable devices, and more particular to an adaptor device for two-way transfer of displayed images between a wearable device and a smart device.

### (b) Description of the Prior Art

High-definition videos are gaining popularity as related technologies are continuously improved. High-definition video signals, however, require large storage space, and their transmission is often limited by bandwidth, protocol, and standard. Conversion or adaption of video signals is therefore often required.

For video output from smart devices (such as desktop computer, notebook computers, tablet computers, smart phones, video players, etc.), there are various interfaces. Video Graphics Array (VGA) is probably still the most popular one so far. In order to pursuit higher video quality, there are so-called Digital Visual Interface (DVI) and High-Definition Multimedia Interface (HDMI) interfaces. It is also common that these interfaces are adapted over the Universal Serial Bus (USB) connection.

Currently, there is still no satisfactory solution for projecting or transmitting video contents from a smart phone (or other smart device) to the screen of a wearable device.

### SUMMARY OF THE INVENTION

Therefore, the present invention provides a display adaptor device for a wearable device, including a casing with a holder socket provided on the casing, a first transmission member including two Universal Serial Bus (USB) ports, one provided inside the holder socket and the other one on an outside surface of the casing, an adaption member including a video processor and an audio codec, and a second transmission member including an input/out (I/O) port on the outside surface of the casing. The first transmission member is electrically connected to the video processor and the audio codec. The video processor and the audio codec are electrically connected to the second transmission member.

The video processor includes an Image Signal Processing (ISP) element and a video codec. The video processor is electrically connected to a video controller provided on the casing. The first transmission member is electrically connected to a power member. The power member includes a rechargeable battery. Both the power member and the rechargeable battery are housed inside the casing.

A cable connects the I/O port and the wearable device. The cable has a controller; and the controller provides a number of control buttons. The controller is removably attached with a wireless controller.

The controller further provides a detector. The adaption member further includes a sensor signal processor electrically connected to the first and second transmission members.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a display adaptor device for a wearable device according to an embodiment of the present invention.

FIG. 1A is a schematic diagram showing the appearance of a display adaptor device according to an embodiment of the present invention.

FIG. 2 is a functional block diagram showing the operation of the display adaptor device of FIG. 1 when it is connected between a smart phone and an intelligence glasses.

FIG. 3 is a schematic diagram showing a smart phone is plugged into the display adaptor device of FIG. 1.

FIG. 4 is a schematic diagram showing a display content of a smart phone shown on a screen of the intelligent glasses through the display adaptor device of FIG. 1.

FIG. 5 is a functional block diagram showing the display adaptor device of FIG. 1 connected to a mobile power bank to charge a smart phone.

FIG. 6 is a functional block diagram showing an image or message of an intelligent glasses delivered and shown on a screen of a smart phone through the display adaptor device of FIG. 1.

FIG. 7 is a schematic diagram showing a detector of the display adaptor device of FIG. 1 detecting a gesture to operate a smart phone or an intelligent glasses.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

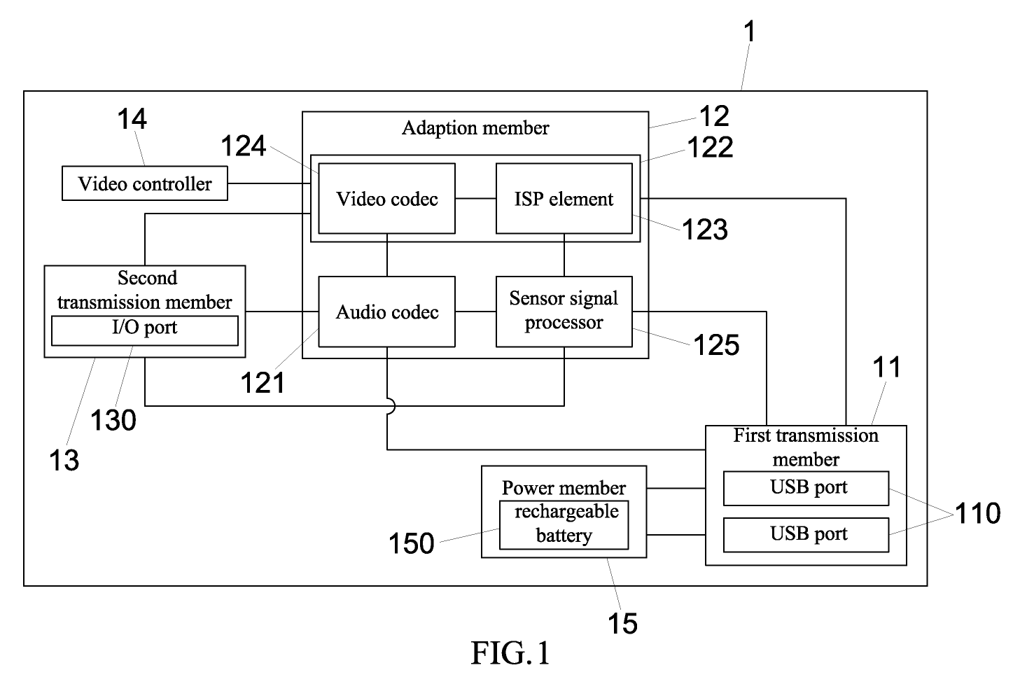

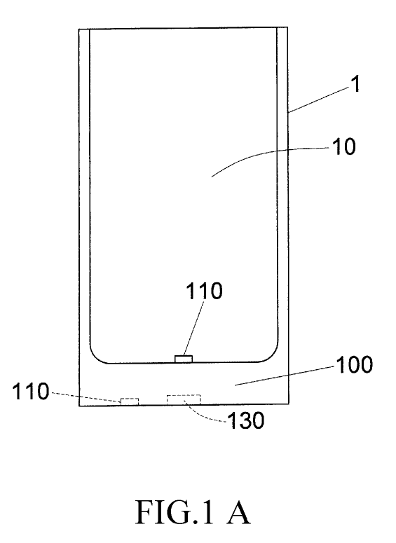

As shown in FIGS. 1 and 1A, the display adaptor device according an embodiment of the present invention includes a casing 1.

A holder socket 10 is provided on the casing 1. Inside the casing 1, the display adaptor device includes a first transmission member 11, an adaption member 12, and a second transmission member 13. The transmission member 11 includes two Universal Serial Bus (USB) ports 110, one is provided inside the holder socket 10 and the other one on an outside surface 100 of the casing 1. The adaption member 12 includes a video processor 122 and an audio codec 121. The first transmission member 11 is electrically connected to the video processor 122 and the audio codec 121, which are also electrically connected to the second transmission member 13. The second transmission member 13 includes an input/out (I/O) port 130 provided on the outside surface 100 of the casing 1.

In the present embodiment, the video processor 122 includes an Image Signal Processing (ISP) element 123 and a video codec 124. Preferably, the ISP element 123 and the video codec 124 are electrically connected, but the present invention is not limited as such.

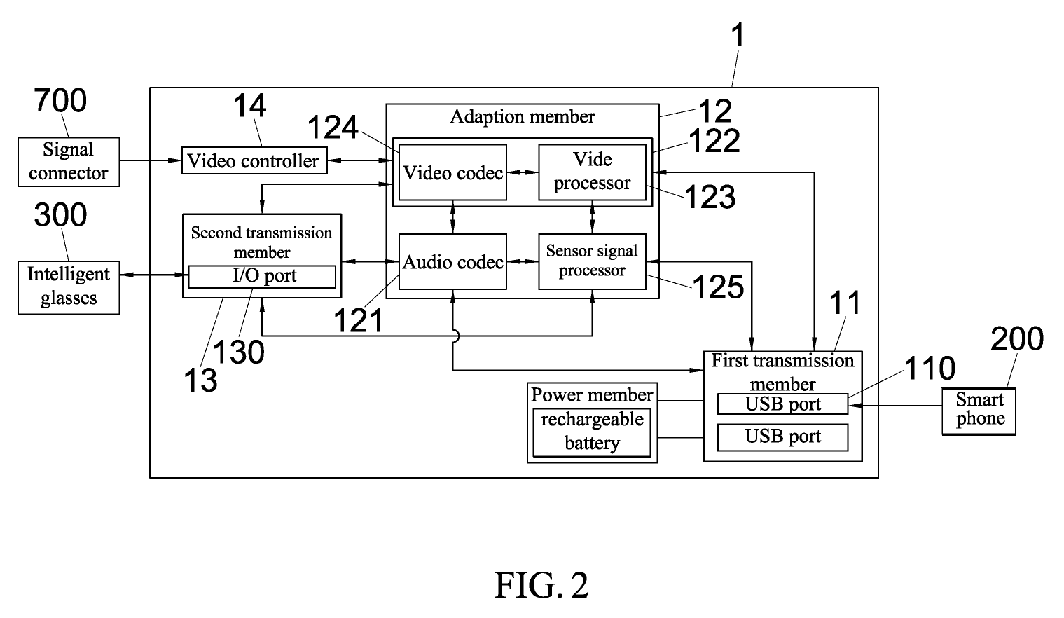

As further shown FIGS. 2 to 4, a smart phone 200 may be plugged into the holder socket 10 and an USB connector 400 of the smart phone 200 is connected to the USB port 110 inside the holder socket 10. Then, a display content 201 (such as a photo or a video image) of the smart phone 200 is transmitted to an intelligent glasses 300 and shown in a screen 301 of the intelligent glasses 300. A photo or a video image captured by the intelligent glasses 300 may also be transmitted to the smart phone 200 and shown on its screen.

After the smart phone 200 is plugged into the holder socket 10, through the operation of a user interface on the smart phone 200, the display content on the smart phone 200 is processed by the ISP element 123 and transmitted through the first transmission member 11 to the intelligent glasses 300. The processing performed by the ISP element 123 may involve gamma correction, interpolation, space change, image effect, image scaling, Automatic White Balance (AWB), Automatic Exposure (AE), Automatic Focus (AF), etc., so that the display content on the smart phone 200 is converted into an image 301 shown on the screen of the intelligent glasses 300 through the I/O port 130 of the second transmission member 13 and a cable 500 connecting the I/O port 130 and the intelligent glasses 300. For example, the I/O port 130 may be an HDMI port and the cable 500 then is an HDMI transmission cable.

Of course the images captured by the intelligent glasses 300 may be compressed by the video codec 124 so as to be shown in the screen of the intelligent glasses 300, or decompressed by the video codec 124 into an original image for showing on the screen of the smart phone 200.

In the present embodiment t, the video codec 124 may be a Joint Photographic Experts Group (JPEG) encoder/decoder, a Moving Picture Experts Group (MPEG) encoder/decoder, etc., so that the video processor 122 is capable image processing and conversion. Similarly, audio signals of the smart phone 200 may be encoded or decoded by the audio codec 121 so that the audio signals are in one or more formats appropriate for the intelligent glasses 300. The processed audio signals is transmitted to the intelligent glasses 300 through the second transmission member 13 and the I/O port 130.

As such, the smart phone 200 or other smart device may be conveniently integrated with the intelligent glasses 300, so as to enhance their product value and market competitiveness, and to increase their applicability and convenience.

The video processor 122 may be electrically connected to a video controller 14 provided on the casing 1. The video controller 14 may be a composite video controller, an HDMI controller, a DVI controller, for the connection of an external signal connector 700 such as AV terminals, HDMI connector, or DVI connector, thereby accepting additional video signal input for greater applicability and convenience.

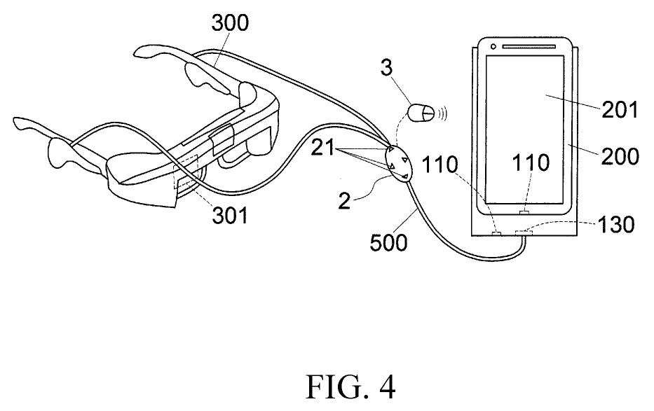

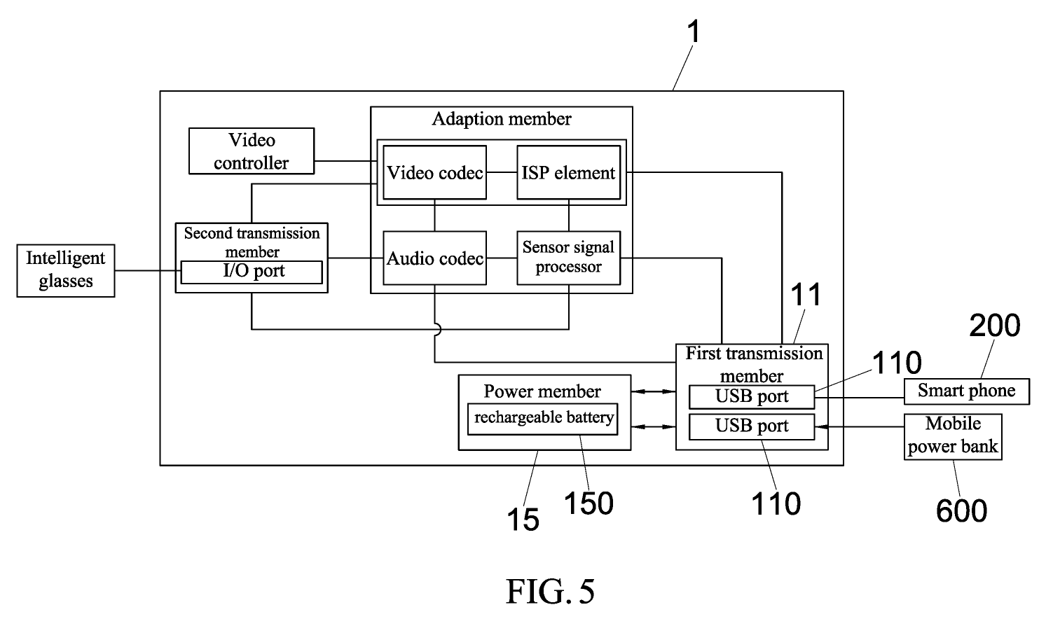

As shown in FIGS. 4 and 5, the first transmission member 11 is electrically connected to a power member 15, which includes a rechargeable battery 150. Both the power member 15 and the rechargeable battery 150 are housed inside the casing 1. In the present embodiment, the USB port 110 on the outside surface 100 may be connected to a mobile power bank 600 and the mobile power bank 600 charges the rechargeable battery 150 through the power member 15 and the first transmission member 11. When the smart phone 200 is plugged into the holder socket 10, the smart phone 200 is electrically connected to the USB port 110 inside the holder socket 10, and the smart phone 200 may be charged by the rechargeable battery 150 through the first transmission member 11 and the power member 15 for greater applicability and convenience. In addition to charging, the USB port 110 on the outside surface 100 may also be connected to an input device such as a keyboard, a mouse, or a camera.

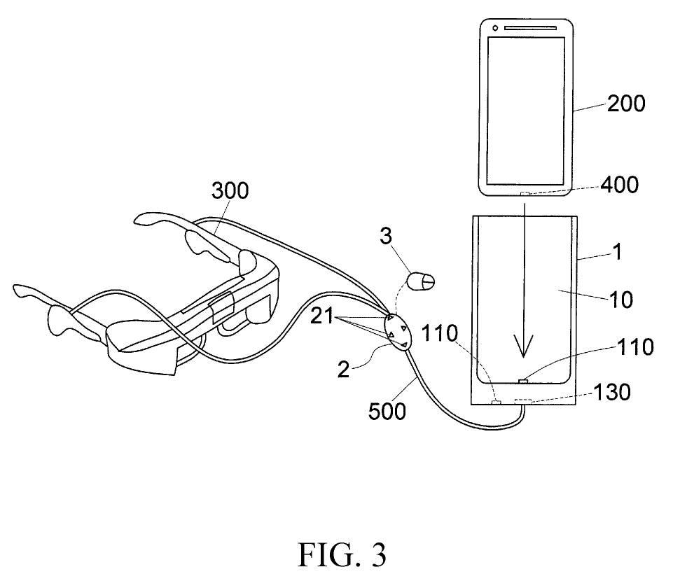

As shown in FIGS. 3 and 4, when a display content 201 of the smart phone 200 is transmitted and shown as an image 301 on the screen of the intelligent glasses 300, the cable 500 has a controller 2 for operating the intelligent glasses 300. The controller 2 provides a control pad with hot keys such as a number of control buttons 21. Through the control buttons 21 on the controller 2's control pad, a number of operations to the image 301, such as image movement and selection, cursor movement, etc., for greater applicability and convenience. The operation on the image 301 may also be achieved by the intelligent glasses 300's built-in function, such as detecting head movement by the intelligent glasses 300's G-sensor.

The controller 2 may be removably attached with a wireless controller 3 by wiring, embedment, or fastening (such as Velcro strips). The wireless controller 3 may be an Air Device like apparatus such as wireless mouse, wireless keyboard, remote controller, etc. In the present embodiment, the wireless controller 3 may establish wireless link with the smart phone 200, and may be used to control the image 301 on the intelligent glasses, for greater applicability and convenience.

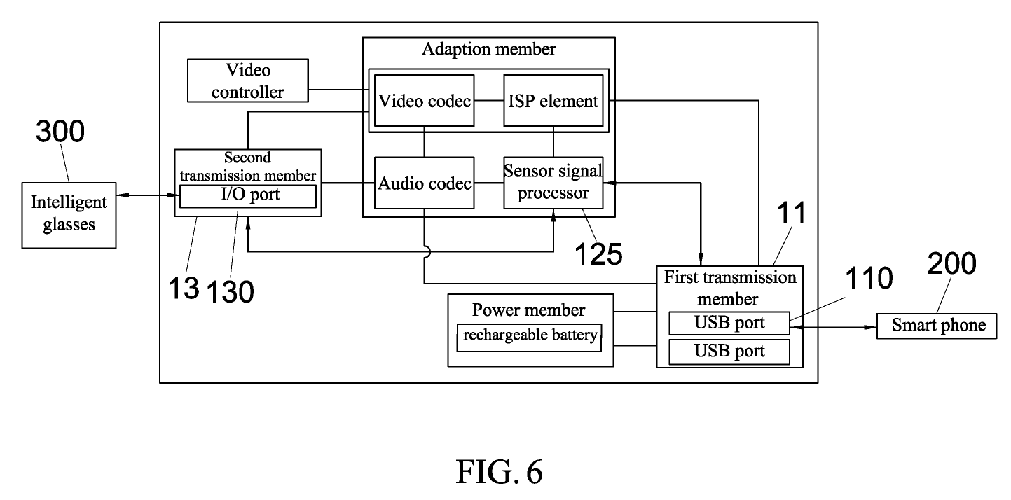

As shown in FIG. 1, the adaption member 12 includes a sensor signal processor 125 electrically connected to the first and second transmission members 11 and 13. As further shown in FIG. 6, sensory signals (such as height, signals from the G-sensor, accelerator) captured by the intelligent glasses 300 or images captured by the camera (for depth detection) are delivered to the sensor signal processor 125 through the I/O port 130 and the second transmission member 13, and then to the smart phone 200 through the first transmission member 11 and the USB port 110. As such, two-way communications between the intelligent glasses 300 and the smart phone 200 is achieved, for greater applicability and convenience.

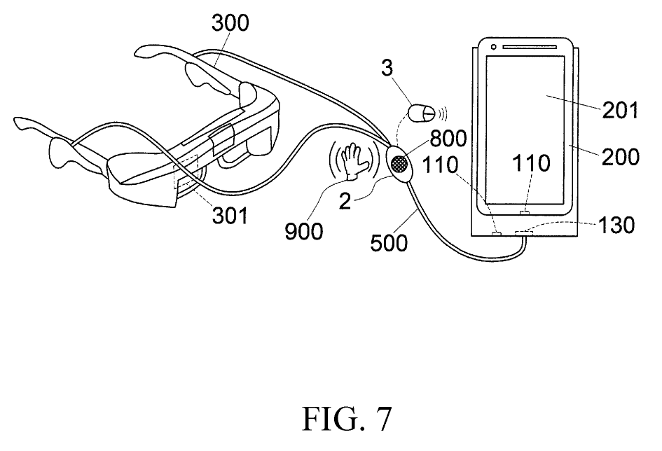

As further shown in FIG. 7, the controller 2 with the control pad and hot keys may have a detector 800 such as a microphone, an infrared detection, or a similar input and detection device. For example, if the detector 800 is a microphone, an audio application or a voice chip on the intelligent glasses 300 or the smart phone 200 may receive voice commands to operate the intelligent glasses or the smart phone 200 such as clicking the cursor, flipping pages, activating applications, etc. When the detector 800 is an infrared detector, the detector 800 may pick up the proximity of a hand 900, or a gesture or movement of fingers of the hand 900, and to operate the intelligent glasses 300 or the smart phone 200 accordingly, for greater applicability and convenience.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A display adaptor device for a wearable device, comprising:
a casing with a holder socket provided on the casing;
a first transmission member comprising two Universal Serial Bus (USB) ports, one provided inside the holder socket and the other one on an outside surface of the casing;
an adaption member comprising a video processor and an audio codec; and
a second transmission member comprising an input/out (I/O) port on the outside surface of the casing;
wherein the first transmission member is electrically connected to the video processor and the audio codec; and the video processor and the audio codec are electrically connected to the second transmission member.

2. The display adaptor device according to claim 1, wherein the video processor comprises an Image Signal Processing (ISP) element and a video codec.

3. The display adaptor device according to claim 1, wherein the video processor is electrically connected to a video controller provided on the casing.

4. The display adaptor device according to claim 1, wherein the first transmission member is electrically connected to a power member; the power member comprises a rechargeable battery; and both the power member and the rechargeable battery are housed inside the casing.

5. The display adaptor device according to claim 1, wherein a cable connects the I/O port and the wearable device.

6. The display adaptor device according to claim 5, wherein the cable has a controller; and the controller provides a plurality of control buttons.

7. The display adaptor device according to claim 6, wherein the controller further provides a detector.

8. The display adaptor device according to claim 6, wherein the controller is removably attached with a wireless controller.

9. The display adaptor device according to claim 1, wherein the adaption member further comprises a sensor signal processor electrically connected to the first and second transmission members.
